(19) United States
(12) Patent Application Publication
(10) Pub. No.: US 2007/0226396 A1
(43) Pub. Date: Sep. 27, 2007

(54) System and method for backing up and recovering data in a computer system

(75) Inventors: Thomas R. Hildner, Cary, NC (US); Claus Michael Olsen, Cortlandt Manor, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/371,017

(22) Filed: Mar. 9, 2006

(51) Int. Cl. G06F 12/00

(52) U.S. Cl. 711/100

(57) ABSTRACT

A method (and system) of backing up and recovering data in a computer system includes incorporating a nonvolatile memory (NVM) into the computer system, backing up data from a storage of the computer system to said NVM, at a first time interval, and backing up data from the NVM to another storage at a second time interval.

### BACKGROUND OF THE INVENTION

1. Field of the Invention

The present invention generally relates to a method and apparatus for backing up and recovering data in a computer system, and more particularly to a method and apparatus for backing up and recovering data in a computer system in which nonvolatile memory (NVM) is used and no “incremental” data is lost.

2. Description of the Related Art

If a hard drive in a computer system malfunctions, and it is not possible to retrieve the data on the drive, then the owner/user of the computer may experience a significant personal loss of data (e.g., uploaded pictures, files, etc.) and/or productivity setback (e.g., spreadsheets and foils, etc.).

The current solution to this exemplary problem is to back up the hard drive at periodic intervals (e.g., once a day, or once every week, etc.) onto the primary HDD, a secondary HDD, a backup server, or some removable media.

However, a problem still arises in that whatever “incremental” data has been created since the last backup cannot be retrieved from the backup server. Thus, prior to the present invention, there has been no method or system which prevents this loss of incrementally-generated data.

There is also a problem if the user has backed up onto the primary HDD. In this case, neither the incremental nor the backed-up data has been saved.

Lastly, there is a problem if the system has crashed before the user saves any data.

### SUMMARY OF THE INVENTION

In view of the foregoing and other exemplary problems, drawbacks, and disadvantages of the conventional methods and structures, an exemplary feature of the present invention is to provide a method and structure for backing up and recovering real time, semi-real time or incremental data in a computer system.

Another feature of the invention is to provide a method and system for backing up and recovering data in which “incremental” data is not lost (or not substantially lost).

In a first exemplary aspect of the present invention, a method (and system) of backing up and recovering data in a computer system includes incorporating a nonvolatile memory (NVM) into the computer system, backing up data from a storage of the computer system to the NVM, at a first time interval, and backing up data from the NVM to another storage at a second time interval.

In a second exemplary aspect of the present invention, a system for backing up and recovering data in a computer system, includes a nonvolatile memory (NVM), a first unit that backs up data from a storage of the computer system to the NVM, at a first time interval; and a second unit that backs up data from the NVM to another storage at a second time interval.

In a third exemplary aspect of the present invention, a method of backing up data in a computer system, includes incorporating a nonvolatile memory (NVM) into the computer system, copying data from the NVM to a storage on the computer system at a given time interval; and subsequently backing up data from the NVM to another storage.

By incorporating a relatively large amount of nonvolatile memory (NVM) into the computer system (e.g., such as ½ GB of Flash storage in a nonlimiting exemplary aspect of the invention; of course, as discussed below, the invention is not limited to such a size or type and indeed any appropriate size or type may be used depending upon the user's requirements and constraints), the hard drive data can be frequently backed-up to the NVM using a modified version of the backup client.

Should the hard drive malfunction, the most recently created data in the NVM can be retrieved by using a reinstalled backup client. It is noted that the data residing in the nonvolatile memory represents data that has not been backed up yet to the network server.

With the unique and unobvious aspects of the invention, it is noted that the incremental data always resides in the NVM (e.g., flash memory).

Thus, with the incremental data on NVM, when it comes time to perform the actual network backup, one can take the data on the NVM and send it to the network server. This is a much faster way of performing the backup than having the backup client determine which new data has been generated and should be backed up. Thus, in that scenario, the storage may operate as a buffer, which is very advantageous with respect to minimizing the time to complete a backup session and reducing the processor load.

It should be noted that the back up method could be manual or automatic. The automatic method could be based on time, event, or remaining capacity of the NVM

With the invention, less data should be lost, thereby leading to less costs, and greater productivity should result.

Another exemplary advantage of the invention is that there should be no need (or little need) to use an information technology (IT) administrator to recover the data. Moreover, with the invention, there will be more peace of mind (e.g., security) and confidence in the system.

Further, the inventive approach is “gentle” on the system, in that it spreads out the backup (e.g., 5 minutes of backup, etc.) across the operating window.

In the case of the primary backup stored on the primary HDD, all data would be gone with an HDD crash. If this procedure was used, then at least the most recent documents would be able to be recovered.

The inventive approach can also be used to save real time or semi real time data. In the real time case, the user data would be saved directly to the NVM in addition to (or instead of) the RAM. In this case, a user could recover the most recent data even if it was not saved. In a semi-real time event, the NVM could be told to save to the NVM every XX seconds or XX minutes.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a system 100 according to a first exemplary aspect of the present invention;

FIG. 2 illustrates a system 200 according to a second exemplary aspect of the present invention;

FIG. 3 illustrates a flowchart of a method 300 according to an exemplary aspect of the present invention;

FIG. 4 illustrates an exemplary hardware/information handling system 400 for incorporating the present invention therein; and

FIG. 5 illustrates a signal bearing medium 500 (e.g., storage medium) for storing steps of a program of a method according to the present invention.

### DETAILED DESCRIPTION OF EXEMPLARY EMBODIMENTS OF THE INVENTION

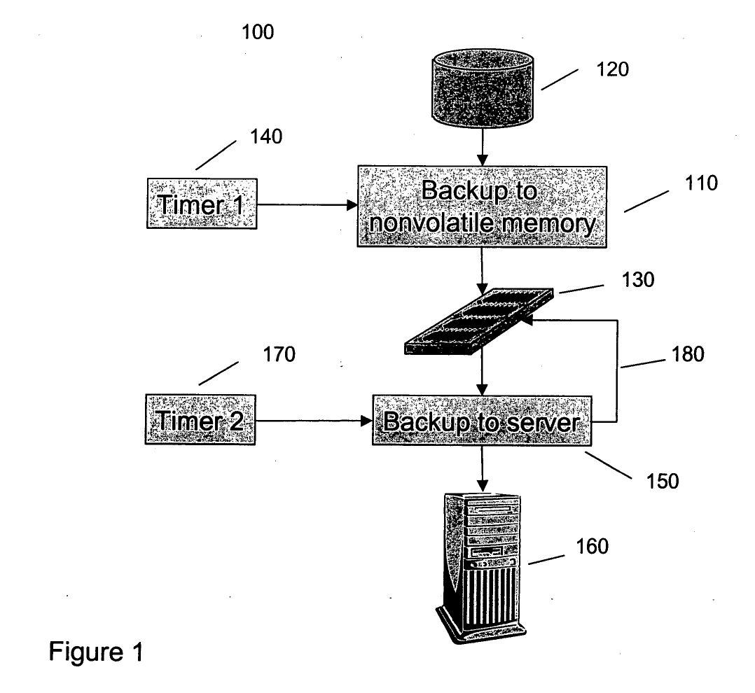

Referring now to the drawings, and more particularly to FIGS. 1-5, there are shown exemplary embodiments of the method and structures according to the present invention.

### Exemplary Embodiment

Briefly, in the present invention, in a computer system, a relatively large amount of nonvolatile memory (NVM) is added to the system. In an exemplary embodiment, the NVM memory may be a ½ GB Flash CF (Compact Flash) or SD (Secured Digital) storage card.

Of course, there is no minimum or maximum amount of storage of the nonvolatile memory, but the size may be application-specific and there may be a trade-off between cost and functionality. For example, the size could be adjusted based on the amount of time elapsed/data generated between network server backups. Ideally, the NVM should be able to contain such an amount of data.

FIG. 1 illustrates an overall system 100 diagram according to an exemplary aspect of the present invention.

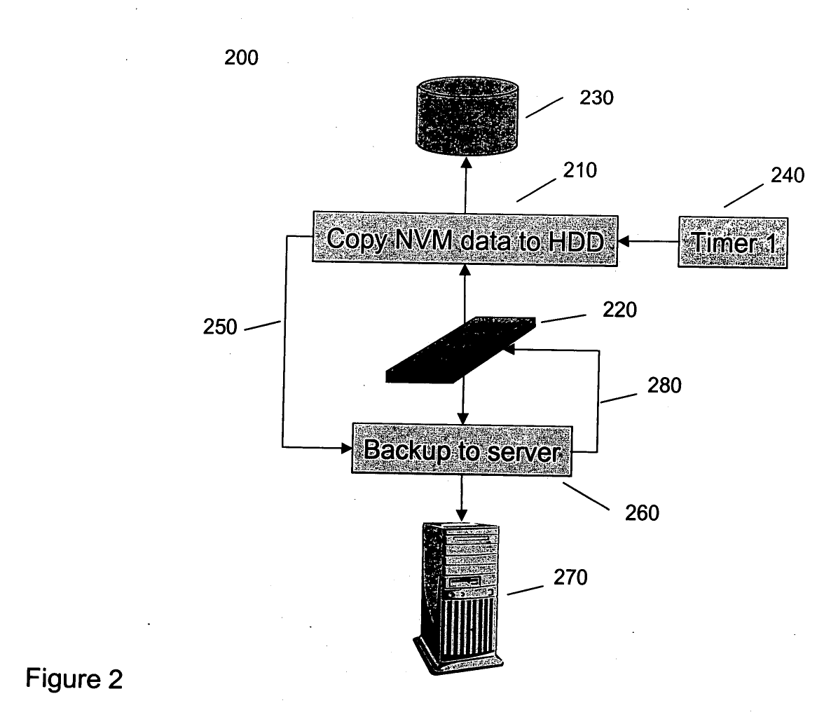

FIG. 2 illustrates a functional block diagram 200 showing an operation according to an exemplary aspect of the present invention.

The invention is not limited to the flash memory for use of NVM 220. Indeed, a random access memory (RAM) backed up by battery 225 could be employed. Alternatively, the nonvolatile memory could be a magnetic medium, an optical disk, a network storage medium, or, for that matter, any other readable/writable (R/W) medium could be used.

In the following, the term “data” is defined as any conceivable type of information that may be stored on a HDD, saved in memory or temporarily or permanently stored, saved or buffered in any other type of storage, memory, buffer and register location. Typically, in backup systems, the data is an entire file, a fraction of a file, a database, or any component of a database, but is not limited thereto.

In the following, the term “copying” is defined as reading data from one storage or memory location, possibly but not necessarily manipulating the data, and then writing the data to another storage or memory location.

In the following, the term “storage” is defined as a medium in which data is kept for a prolonged period of time.

In the exemplary embodiment 100, as shown in FIG. 1, an assumption is that, whenever new data is first created (e.g., when a file is modified by a word processing application), the new data is first stored onto a hard disk drive (HDD) 120 by a file manager of an operating system.

In embodiment 100, a first software module 110, for example working as an extension of the backup client software (e.g., the TSM (Tivoli Storage Manager) or IBM's Rescue and Recovery) periodically backs up newly-created data from the HDD 120 to a nonvolatile memory (NVM) 130. It does so with a fine grain interval governed by Timer1 140 which could be 1 hour, but is not limited thereto.

A second software module 150 in turn backs up all the data stored in the NVM 130 to the network server 160. It does so with a possibly longer time interval governed by Timer2 170 which could be 1 week, but is not limited thereto. After each data is successfully backed up on the server, the corresponding data may be erased from the NVM in step 180.

The software module 110 interacts with the file manager of the operating system to determine which data on the HDD 120 is new and subsequently backs them up to the NVM 130.

In an alternative embodiment 200, as shown in FIG. 2, the assumption is that new data is first stored in the NVM 220.

In the second embodiment 200, a software module 210 copies the new data from the NVM 220 onto a HDD 230 at a time interval governed by Timer1 240 which could be 1 week, but is not limited thereto. Once all data has been copied to the HDD 230, the software module 210 notifies (e.g., through connection/step 250 in FIG. 2) a backup software module 260 which in turn backs up all data from the NVM 220 to the network server 270. After all data is successfully stored on the server, the corresponding data may be erased from the NVM (e.g., through connection/step 280).

In embodiment 200, the NVM is treated as a buffer between the file manager and the HDD. This is an advantageous embodiment of the present invention with respect to saving power in the HDD which can be kept spun down until it is time to flush the NVM or until the operating system needs to perform a read from the HDD.

It is noted that the NVM can be used to backup any memory system 230. Thus, in lieu of, or in addition to, the hard drive, the flash storage can back up RAM, other removable media, etc.

In case of a hard drive crash, the backup software can reinstall and reconfigure and the primary backup data from the primary backup device and also recover the incremental, semi-real-time or real-time data from the NVM.

Should the NVM storage 220 become full (or reach a predetermined capacity) as determined by a NVM capacity determining module or the like, a network backup session may be forced as soon as possible to optimize data safety. Subsequently, the nonvolatile memory (e.g., the Flash card) may be erased by a read/write module or the like.

On regular scheduled backup sessions (e.g., once every day, etc.), the content of the nonvolatile (e.g., Flash card) storage 220 may be backed up. Subsequently, the NVM is erased by a read/write module 260.

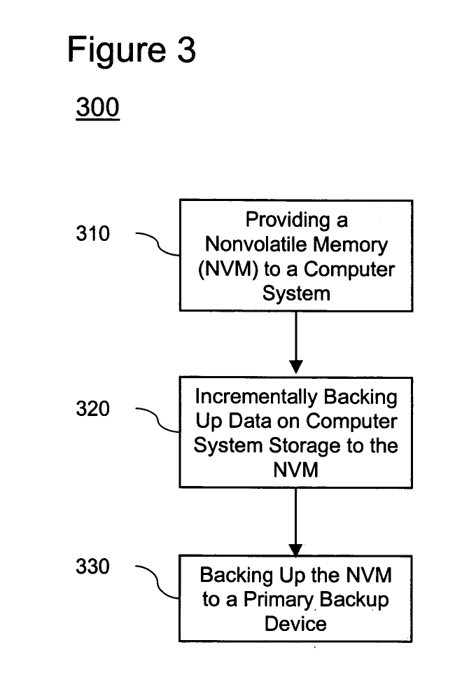

FIG. 3 illustrates a flowchart of a method 300 according to an exemplary aspect of the present invention. In step 310, a nonvolatile memory (NVM) is provided to the computer system. In step 320, data is incrementally backed up on a storage of the computer system to the NVM, in any of a periodic interval, an event driven time, or an algorithmic response time. In step 330, the NVM may be backed up to another storage (e.g., a primary backup device) in a second periodic interval.

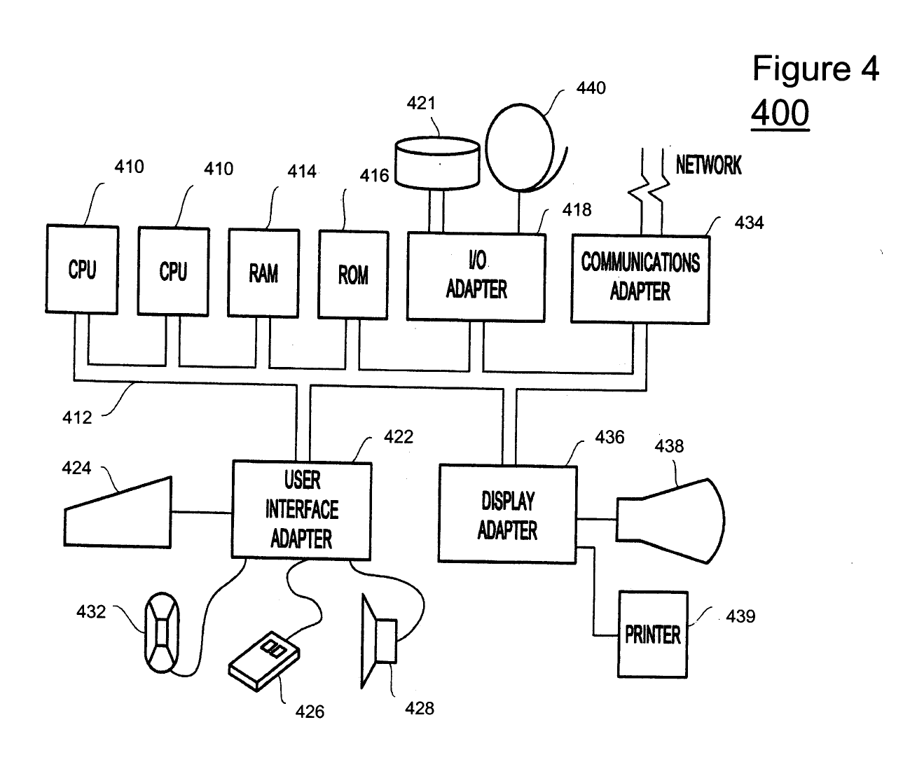

FIG. 4 illustrates a typical hardware configuration of an information handling/computer system for use with the invention and which preferably has at least one processor or central processing unit (CPU) 410.

The CPUs 410 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting an information handling system to a data processing network, the Internet, an Intranet, a personal area network (PAN), etc., and a display adapter 436 for connecting the bus 412 to a display device 438 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

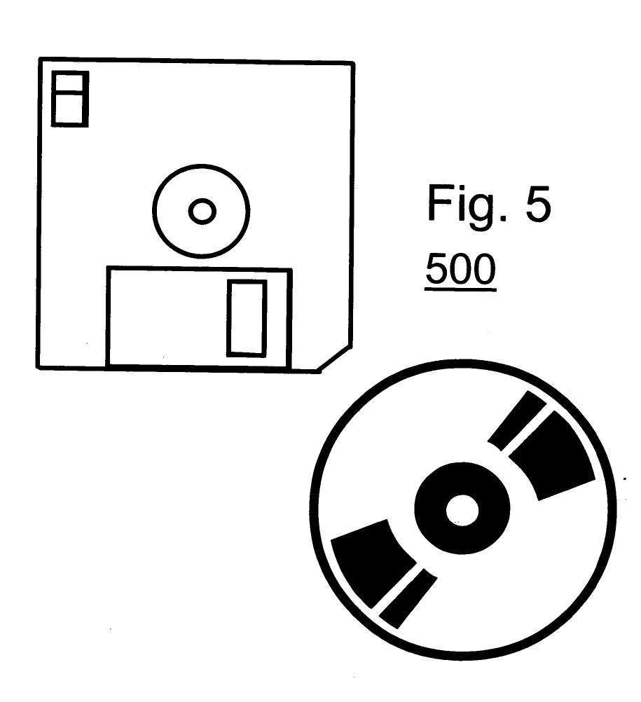

This signal-bearing media may include, for example, a RAM contained within the CPU 410, as represented by the fast-access storage for example. Alternatively, the instructions may be contained in another signal-bearing media, such as a magnetic data storage or CD-ROM diskette 500 (FIG. 5), directly or indirectly accessible by the CPU 410.

Whether contained in the diskette 500, the computer/CPU 410, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

Additionally, in yet another aspect of the present invention, it should be readily recognized by one of ordinary skill in the art, after taking the present discussion as a whole, that the present invention can serve as a basis for a number of business or service activities. All of the potential service-related activities are intended as being covered by the present invention.

While the invention has been described in terms of several preferred embodiments, those skilled in the art will recognize that the invention can be practiced with modification within the spirit and scope of the appended claims.

For example, different implementations may be provided in which the hard drive and the nonvolatile memory may be backed up at the same time, or can write to the nonvolatile memory and then such can be cached periodically to the hard drive, and then an incremental backup may be performed.

It is noted that it has been described that the NVM may be backed up to another storage (e.g., a primary backup device or the like) in a second periodic interval. It is noted that such a primary backup device may be any type of memory described above, including backup servers, network servers, hard disk drives, optical disks, etc.

Further, it is noted that, Applicant's intent is to encompass equivalents of all claim elements, even if amended later during prosecution.

What is claimed is:

1. A method of backing up and recovering data in a computer system, comprising:
incorporating a nonvolatile memory (NVM) into said computer system;
backing up data from a storage of said computer system to said NVM, at a first time interval; and
backing up data from said NVM to another storage at a second time interval.

2. The method of claim 1, wherein said another storage comprises a primary backup device, and wherein said first time interval is shorter than said second time interval.

3. The method of claim 1, wherein said NVM comprises a flash storage.

4. The method of claim 3, wherein said flash storage functions as a buffer memory.

5. The method of claim 1, wherein said NVM comprises one of a battery-backed up random access memory (RAM), a magnetic medium, an optical disk, a network storage medium, and/or another readable/writable (R/W) medium.

6. The method of claim 1, wherein incremental backup data segments are stored onto said NVM in a same fashion as said another storage.

7. The method of claim 1, further comprising:
in a case of a storage malfunction, reinstalling and reconfiguring a backup client, and forwarding the backup data in said NVM to said another storage.

8. The method of claim 7, further comprising:
erasing said NVM and initiating a regular backup recovery procedure to restore all lost data files.

9. The method of claim 8, further comprising:
when a capacity of said NVM reaches a specified limit, forcing a backup session of said NVM; and
erasing said NVM.

10. The method of claim 8, further comprising:
when a specified event is achieved, forcing a backup session of said NVM; and
erasing said NVM.

11. The method of claim 8, further comprising:
when a specified time period or time event occurs, forcing a backup session of said NVM; and
erasing said NVM.

12. The method of claim 8, further comprising:
manually forcing, by a user, a backup session; and
erasing said NVM.

13. The method of claim 1, further comprising:
on regular scheduled backup sessions forwarding a content of said NVM to a backup network server; and
erasing said NVM.

14. The method of claim 1, wherein said storage comprises one of a hard disk drive and a random access memory.

15. A system for backing up and recovering data in a computer system, comprising:
a nonvolatile memory (NVM);
first means for backing up data from a storage of said computer system to said NVM, at a first time interval; and
second means for backing up data from said NVM to another storage at a second time interval.

16. The system of claim 15, wherein said NVM comprises an external memory and wherein said NVM comprises a flash storage.

17. The system of claim 15, wherein said NVM comprises a memory internal to said computer system and wherein said NVM comprises a flash storage.

18. A signal-bearing medium tangibly embodying a program of machine-readable instructions executable by a digital processing apparatus to perform a method of backing up and recovering data in a computer system according to claim 1.

19. A method of backing up data in a computer system, comprising:
incorporating a nonvolatile memory (NVM) into said computer system;
copying data from said NVM to a storage on said computer system at a given time interval; and
subsequently backing up data from said NVM to another storage.

20. A signal-bearing medium tangibly embodying a program of machine-readable instructions executable by a digital processing apparatus to perform a method of backing up data in a computer system according to claim 19.
